(19) United States
(12) Patent Application Publication
(10) Pub. No.: US 2015/0009654 A1
(43) Pub. Date: Jan. 8, 2015

(54) Gemstone Illuminator

(71) Applicant: Jewelectric, Kowloon (HK)

(72) Inventors: Johnny Yat Ming Chan, Irvine, CA (US); Sun Fai Oskar Wong, Kowloon (HK)

(21) Appl. No.: 14/320,175

(22) Filed: Jun. 30, 2014

Related U.S. Application Data
(60) Provisional application No. 61/841,619, filed on Jul. 1, 2013.

(51) Int. Cl. H05B 33/08; F21S 9/02; H05B 37/02; F21V 33/00

(52) U.S. Cl. CPC H05B 33/0857; F21V 33/0008; F21S 9/02; H05B 37/0272; H05B 33/0845; F21W 2121/06
USPC 362/104

(57) ABSTRACT

Devices and methods are disclosed for illuminating gemstones on fashion accessories a variety of colors. The device may process certain inputs to determine the color emanating from a light source that will illuminate the gemstone. The device may be integrated with a mobile application that wirelessly controls the color of the gemstone through a wireless connection to a light source. The device advantageously will allow input from the microphone or camera of the mobile device to change the color of the gemstone based on the ambient light or sound.

### CROSS REFERENCE TO RELATED APPLICATIONS

This application claims priority to U.S. Provisional Application No. 61/841,619 filed Jul. 1, 2013, the contents of which are incorporated herein by reference.

### BACKGROUND

Consumers wear jewelry encrusted with gemstones due to their aesthetically pleasing qualities. For example, certain gemstones, including diamonds, refract or reflect a large portion of the absorbed light back toward the human eye, giving them a brilliant, sparkling appearance. Additionally, other gemstones naturally occur in many different colors including green, white, yellow, turquoise, rainbow, black and others. Accordingly, consumers associate gemstones with their brilliant colors and capacity for reflecting and dispersing ambient light.

However, because gemstone colors vary, users must purchase several different colored pieces of jewelry to match the various articles of clothing they own. For example, if a consumer buys a green jade necklace, it will not likely match a red blouse. As gemstones are expensive, purchasing jewelry to match each outfit may be cost prohibitive. Accordingly, some consumers resign themselves to purchasing neutral colored or clear jewelry that matches most clothing while sacrificing color variety. Additionally, gemstones may not be visible or attention-grabbing in low light situations, as they do not emit their own light.

### SUMMARY

Therefore, a need exists for systems and methods that provide additional light to gemstones and that can alter the color of gemstones, for example to match different colored articles of clothing. Accordingly, systems and methods have been developed for illuminating gemstones using light sources, some of which may have variable colors. In some embodiments, the system is used to enhance pieces of jewelry or other fashion accessories worn by a user.

### BRIEF DESCRIPTION OF THE DRAWINGS

Aspects and many of the attendant advantages of this disclosure will become more readily appreciated as the same become better understood by reference to the following detailed description, when taken in conjunction with the accompanying drawings, wherein:

FIG. 1 is an overview of a gemstone illuminator system in connection with the present disclosure.

FIG. 2 is a cross-section of a gemstone recess with an illumination apparatus installed inside in an embodiment of the present disclosure.

FIG. 3a is a circuit diagram showing an embodiment of a system for illuminating multiple gemstones.

FIG. 3b is a circuit diagram of another embodiment of a system for illuminating multiple gemstones.

FIG. 4 is a flow chart illustrating the control sequence for illuminating gemstones based on various inputs in an embodiment of the present disclosure.

FIG. 5 is an overview of a general gemstone illuminator system in connection with the present disclosure.

FIG. 6 is a perspective view of a back side of a gemstone illuminator mount.

FIG. 7 is a perspective view of a front side of a gemstone illuminator mount.

FIG. 8 is a side view of the gemstone illuminator mount.

FIG. 9 is a perspective view of a frame of a gemstone illuminator mount.

FIG. 10 is a perspective view of a gemstone that has been machined to fit into a frame of a gemstone illuminator mount.

### DETAILED DESCRIPTION

The present disclosure describes systems and methods that may illuminate and/or modify the observed color of gemstones. Embodiments of the invention will now be described with reference to the accompanying figures, wherein like numerals refer to like elements throughout. The terminology used in the description presented herein is not intended to be interpreted in any limited or restrictive manner, simply because it is being utilized in conjunction with a detailed description of embodiments of the invention. Furthermore, embodiments of the invention may include several novel features, no single one of which is solely responsible for its desirable attributes or which is essential to practicing the inventions herein described.

The described systems and methods may use any suitable light source or other methods appropriate for manipulating the color of a gemstone, including running current through liquid crystal. For example, current running through liquid crystal may change a gemstone from white to black. Another embodiment may incorporate an LED based light sourced focused on a gemstone. In this embodiment, the LED illuminates the gemstone with the color of the light emanating from it. A light source may be attached to the setting of the gemstone, or a manufacturer may machine a recess in the gemstone to accommodate the light source and the accompanying circuitry. In addition to LEDs, manufacturers may use any suitable light source for illuminating gemstones in different colors.

All or a majority of the electronic components of the system may be retained within a recess in the gemstone. A manufacture may machine the recess using standard tools known in the industry by forming a cavity that is an appropriate size and shape to fit the electronic components. This may be particularly advantageous for fashion accessories that include minimal extra components other than the gemstone, such a ring or earing stud. In other embodiments, the electronic components may be adjacent to the gemstone rather than in a recess, for instance underneath the gemstone.

However, in another embodiment, the electronic components may be distributed on different parts of the fashion accessory, potentially removed from the gemstone. In some embodiments, the light source alone or both the light source and circuit board may be enclosed within or attached adjacent to the gemstone, while the additional electronic components may distributed on different portions of the accessory. For example, manufacturers that incorporate this system into a necklace may find it advantageous to locate some of the electronic components on portions of the chain or the pendants that are remote from the gemstone.

In some embodiments, the system may include components to illuminate several gemstones. Manufacturers may illuminate a cluster of gemstones using a single light source and controller. Alternatively, manufacturers may illuminate several gemstones by providing an individual light source for each gemstone. This may be necessary when the gemstones are spaced significantly apart from one another along the fashion accessory.

A manufacturer may control the multiple light sources using separate control systems, for example microcontrollers, to light each gemstone. This advantageously allows the gemstones to be lighted in different colors simultaneously. Alternatively, a manufacturer may provide a single controller that directs the color of the separate light sources. This configuration will save cost and weight, but will only allow a single color to be emitted from each of the light sources at one time.

Additionally, the gemstone illuminator system may function in a stand-alone configuration with the light source controls may be directly fastened to the jewelry. Also, the gemstone illuminator may be arranged in a connected mode where a mobile application wirelessly controls the light source. In the standalone configuration, the controls may be physically wired to the electronic components and fastened to the jewelry. The controls may include a power switch, and other dials or controls to manipulate the color characteristics of the light source.

The connected configuration includes either a Bluetooth or other wireless connection to a mobile device. The user may download an application on their mobile device to control the color of the light source. After the user provides input through the application interface, the application may send instructions wirelessly to the light controllers on the jewelry. Additionally, integration with the mobile device will provide additional functionality based on input from the mobile device's camera, microphone, and the internet. For example, the application may send instructions to modify the light source based on sound detected by the microphone. Accordingly, the jewelry may be set to flash when entering a room with music.

Additionally, a user could aim a mobile device's camera at an article of clothing to detect its color and output a color scheme from the light source that matches the clothing. Additionally, the input from the camera could be used to dim or brighten the illumination of the gemstone based on the brightness of the ambient light.

Furthermore, the application may process input from the internet or other network related to a third party's utilization of the system. For example, information regarding the location and preferences of a third party in relation to the user may dictate the color scheme of the user's or third party's jewelry. Accordingly, games may be played that modify the observed color of the gemstones based on interactions between different users utilizing the disclosed system.

Systems, methods, and computer-readable media are disclosed for modifying the observed color of gemstones that are components of fashion accessories including necklaces and rings. The observed color may be manipulated by a user controlling a light source adjacent to a gemstone. The control may be accomplished manually through a hardwire connection to the system or by a mobile application that is wirelessly integrated with the system. This allows users to coordinate the colors of the gemstone on a single piece of jewelry with different colored articles of clothing. Additionally, integration with a mobile device allows the user to program the system to manipulate the observed chromatic qualities of the light source based on audio input, such as the ambient music.

This system advantageously allows users to save money by purchasing fewer articles of jewelry and make fashion statements not possible through traditional jewelry. Additionally, integration with a mobile application allows users to play social networking games based on proximity to other users or other criteria.

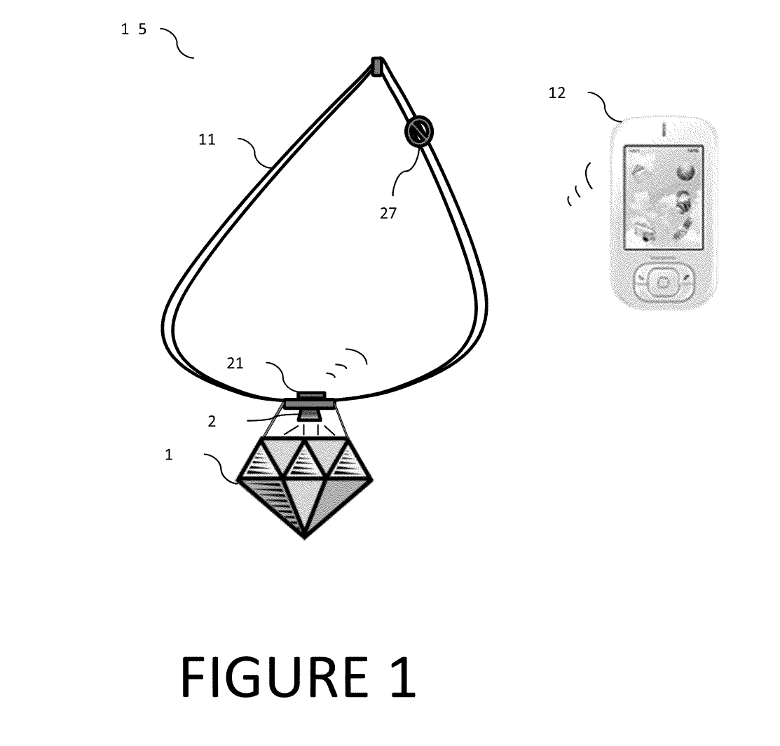

FIG. 1 illustrates an overview of an example of a gemstone illumination system 105. An illumination system 105 may include a gemstone 100 connected to a fashion accessory 110, that includes a light source 200. A manufacturer may place the light source 200 adjacent to the gemstone 100 to illuminate it in a plethora of colors and shades, or implement other visual effects. The system may be controlled by manual controls wired to the system or by a mobile application installed on a mobile device 120 that is connected to the mobile device via a wireless link 210.

The system 105 may include multiple gemstones 100 that are illuminated by the same light source 200 or each illuminated by their own light source 200. Accordingly, some gemstones 100 may be set in close proximity on the same setting, for example in a ring, and therefore one light source 200 may be sufficient to change their color. In some embodiments, the user may wish to illuminate each individual gemstone 100 a different color, and therefore an individual light source 200 for each individual gemstone 100 may be required. In an embodiment, the light source 200 may be aimed at a specific gemstone 100 while the light source's light is simultaneous blocked out from adjacent gemstones 100 with a separator or other divider. This may allow each gemstone 100 to be illuminated with a specific color without contamination from adjacent light sources 200.

In a configuration including wired controls, the user may manually control the light source 200, or the system 105 may include preprogrammed sensors and logic that automatically control the light source 200 based on the input from the sensors. For example, the system may include capacitance sensors so the light source 200 is only activated when the system is being worn by a user. In another example, the system may include audio or visual sensors that sense when music is playing or the ambient light conditions change. Thus, the light source 200 may flash when it detects music or turn off when placed in a jewelry box. The manufacturer may include manual controls 270 wired to the fashion accessories 110 including, but not limited to, a power switch, and dials or other controls for changing the color, brightness, or creating blinking patterns or other visual effects.

Light source 200 may be a variety of suitable light sources known in the art included, but no limited to LEDs, incandescent bulbs, fiber optics, and others. Manufacturers of the device may incorporate an LED as the light source 200. LEDs are advantageous as they have relatively low power requirements but may emit approximately 3 million different colors. Thus, the LED may emit a far greater number of color combinations than are available by purchasing natural or even synthetic gemstones. Additionally, use of an LED or other light source 200 allows the user to create flashy visual effects like progressive changes or strobing effects not possible with static color gemstones. In some embodiments, the light source 200 may be activated in dark environments. This allows the fashion accessory incorporated with the disclosed system to be particularly eye-catching.

Gemstones 100 may be any variety of gemstones that are sufficiently transparent or transmit enough light to allow light source 200 to manipulate the observed color of a gemstone 100. Additionally, certain gemstones 100 have a capacity for reflecting, dispersing, and/or refracting light, for example, diamonds, and may additionally provide added visual flair when illuminated by light source 200. Finally, plastics or synthetic gemstones 100 may be used that are typically used to accent fashion accessories as substitutes for natural gemstones.

Wireless link 210 may incorporate any suitable wireless connection technology known in the art, including but not limited to Wi-Fi (IEEE 802.11), Bluetooth, other radio frequencies, Infra-Red (IR), GSM, CDMA, GPRS, 3G, 4G, W-CDMA, EDGE or DCDMA200 and similar technologies. A wireless link may be formed with a mobile device 120 in order for a mobile application running on the mobile device 100 to manipulate the color emitting from light source 200. Additionally, some embodiments may include a wired connection capability, including through RS-232 ports, in order for a computer or mobile device to be temporarily connected to update or change the programming of the system 105. Thus, new logic may be implemented on software downloaded over the RS-232 port that changes the algorithm for determining the characteristics of the light emitted from the light source 200 based on certain inputs.

Mobile device 120 may be any suitable mobile computing device, including smart phones, tablets, laptops, and other computing devices known in the art. In certain embodiments, the light source 200 may only be powered up when a wireless connection is formed between the wireless link 210 and the mobile device 120. This advantageously allows the system 105 to save power and only wake up when a user is likely wearing the fashion accessory as most users only carry their mobile devices 120 when outside the home. Thus, the gemstone 100 will be illuminated only when the user is in social environments when the aesthetic advantages created by the presently disclosed device are particularly important. In some embodiments, the user may power up the light source 200 through interaction with an application installed on the mobile device 120, but the light source 200 will remain illuminated following disconnection of the wireless link 210. In this example, the light source 200 may remain illuminated until the time when it is turned off through the mobile application, manual switch, or other means.

Fashion accessories 110 may be any personal accessories that incorporate gemstones 100 including, but not limited to, necklaces, rings, watches, earrings, studs, bracelets, tiaras, car ornaments, home decor, phone cases, eyeglass frames, and bling of any kind. The electronic components of the system 105 that support the light source 200 may be incorporated adjacent to or inside a recess of a gemstone 100. Additionally, the electronic components may be located farther away from the gemstone 100 on the fashion accessory 110 in an inconspicuous location, and connected with a wired or wireless connection. For example, if a necklace is used, the additional electronic components including the manual controls 270 may be attached near the clasp while connected to the light source 200 via a wire running inside or along the necklace chain.

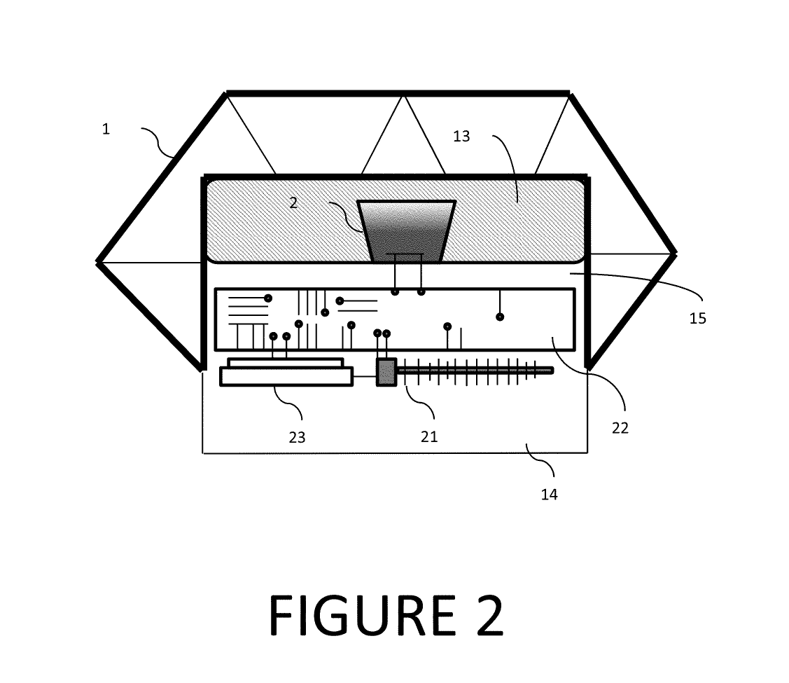

FIG. 2 illustrates a detailed cross section of a gemstone 100 including a recess 150 that houses the light source 200 and associated electronic components. For example, a manufacturer of the system 105 may machine a recess 150 into the gemstone 100 that accommodates all or a portion of the following components: a light source 200, light source mount 130, circuit board 220, battery 230, wireless link 210, and component mount 140. Accordingly, these components may be hidden from view inside the gemstone 100, while the brightness of the light source 200 prevents the user or third parties from seeing the electronics through the gemstone 100.

In another example, the majority or all of the electronic components may be attached to a gemstone 100 setting, rather than or in addition to being enclosed within a recess 150 of the gemstone itself. This embodiment will eliminate the expensive and intricate machining required to produce an appropriately sized recess 150 in a gemstone 100. If the light source 200 is not adjacent the gemstone 100, the light emanating from light source 200 may be routed to gemstone 100 through fiber optics or mirrors, or magnified or filtered appropriately to produce desired affects.

Producers of the disclosed system 105 may use a variety of methods to manufacture its components. For example, manufactures may machine a recess 150 into gemstone 100 using methods known in the gemstone industry in order to provide a convenient means of concealing the electronic components from view. The manufacturer may mount the light source 200 facing outwardly toward gemstone 100, to best illuminate it when attached to a fashion accessory 110. The manufacturer may mount the light source 200 using a variety of mechanical means, including attaching the light source 200 to a light source mounting 130. The light source mounting 130 may include a variety of mechanical or chemical means known in the art including encasing the light source 200 in a transparent epoxy, gluing the light source 200 directly to the gemstone 100, or attaching the light source 200 to a mounting foundation 130 that is anchored to the gemstone 100. In some embodiments, the manufacturer may screw or nail the light source 200 into a gemstone 100. In another example, a manufacturer may machine a recess 150 into a gemstone 100 so that the light source 200 or other electronic components fit inside the recess 150. In some embodiments, a plastic or metal cover may be affixed to the opening formed by the recess 150 to retain the electronic components, or the recess 150 may be filled with a transparent epoxy to retain the components.

All or a portion of the electronic components (i.e., light source 200, circuit board 220, battery 230, and wireless link 210) may be included within the recess 150. In some embodiments, the electronic components may be connected via a wired or wireless connection to the light source 200 and located further away from the gemstone 100. In some embodiments, the electronic components may be attached directly to the light source mounting 130, or attached to a component mounting 140 that is connected either to the light source mounting 130 or directly to the gemstone 140. In some embodiments, the light source 200, circuit board 220, battery 230, and wireless link 210 may all be included in recess 150 and contained by component mounting 140. In some embodiments, the component mounting 140 may be an epoxy, or a cover that retains the electronic components within a recess 150.

Some embodiments may include a pre-manufactured device that includes the electronic components with a window for the light source 200. Advantageously, this could be easily incorporated into the setting of a variety of fashion accessories 110 without customization or machining on each individual piece of jewelry. This would allow manufacturers of the system to purchase the component and easily attach it to the fashion accessories 110, saving significant costs for customizing the system 105 for each fashion accessory 110.

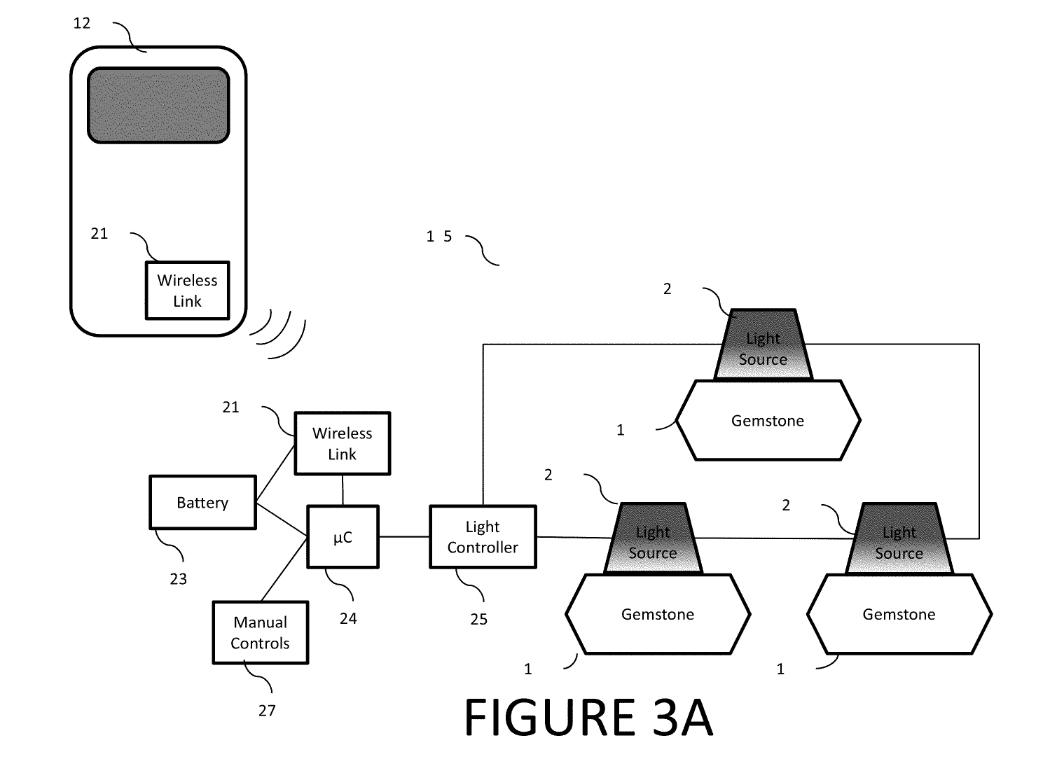

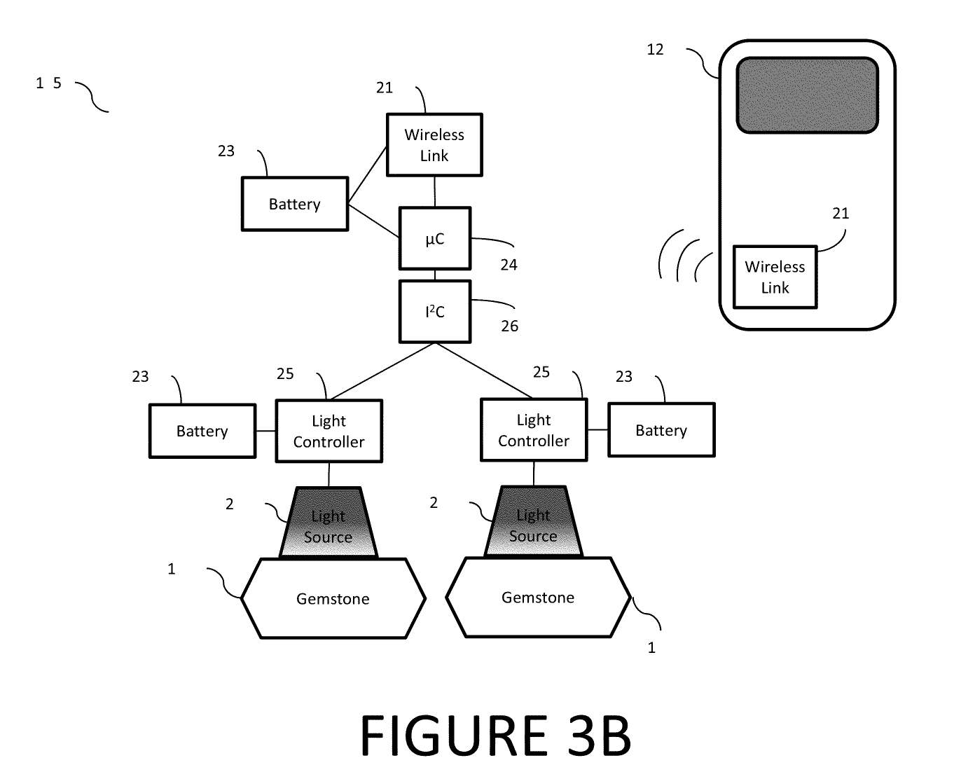

FIG. 3A illustrates an example circuit diagram implementing the gemstone illuminator system 105. The circuit includes a controller 240 that receives input or instructions from a mobile application through the wireless link 210 or from manual controls 270. A battery 230 powers the controller 240 and wireless link 210. The controller 240 sends instructions to a light source controller 250 that drives the color, shade, and other qualifies of the light being emitted from the light source 200.

The controller 240 may be any suitable device for controlling the emitted light from a light source 200, including basic circuits for implementing manual controls, a processor or other computing device including, but not limited to a microcontroller, or a microprocessor. The battery 230 may be any suitable device known in the art including rechargeable batters, lithium batteries, and others. The manual controls 270 may be any suitable manual controls that could be mounted on a fashion accessory 110 including but not limited to buttons, touch sensor, switches, dials, and other appropriate controls. The manual controls 270 may turn the system 105 on and off, may change the observed color, shade, and other features of the system discussed herein.

FIG. 3A illustrates a circuit diagram showing an embodiment that incorporates multiple gemstones 100 and associated light sources 200. Particularly, FIG. 3A illustrates an embodiment where multiple light sources 200 are connected in series. In this embodiment, each of the light sources 200 may at all times be emitting light with the same chromatic qualifies as the light controller 250 may not send individual instructions to each light source 200.

Alternatively, FIG. 3B illustrates a circuit diagram in which multiple light sources 200 are controlled independently in order to create complex visual effects through illumination of gemstones 100. In this configuration, each light source 200 and its accompanying gemstone 100 contains a separate light controller 250 and battery 230. In some embodiments, a single battery 230 may power each of the electronic components. An inter-integrated circuit (I2C) 260 may also be implemented between the master controller 240 and slave light controllers 250 to relay instructions between them. In another embodiment, the controller 240 may relay the instructions directly to the two light controllers 250.

Thus, the controller 240 may provide unique instructions to each light controller 250 creating different colored light being emitted simultaneously from the two light sources 200. This allows the user to create progressive patterns that create the illusion of moving lights, a progressive fade pattern, multicolored jewelry, or other visual effects.

FIGS. 3A and 3B both illustrate a system 105 integrated (e.g., wirelessly) with a mobile device 120. In this configuration, a wireless link 210 associated with the fashion accessory 110 may form a wireless connection with the wireless link 210 associated with the mobile device 120. Thus, information and instructions may be communicated between the two wireless links 210. In order to control the light sources 200 with the mobile device 120, the user may download an application that provides specific instructions to the controller 240.

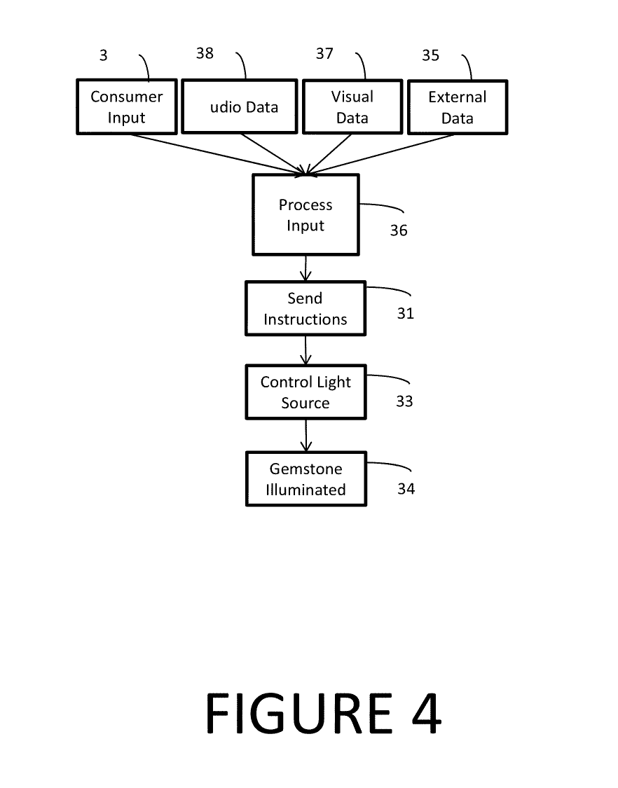

FIG. 4 illustrates a flow chart providing an embodiment of the basic functioning logic for controlling the light source 200. The device may first receive a variety of inputs that are processed to determine the light source 200 output. The input may include user input 300 from either an application on a mobile device 120, manual controls 270, or other means. Next, the system 105 may process the input 360 to determine a desired output of the light source 200. For example, the input may be a user instructing the system 105 to turn the light source 200 a certain color, to brighten it, or to turn it on or off. The processing of the input 360 may be performed by the controller 240, the application on the mobile device 120, or another processor on an associated computing device. The processing may be performed based on pre-recorded logic or software stored on a memory in electronic communication with the system, or on the mobile device 120. Next, the system 105 converts the desired output of the light source 200 into a set of instructions, and sends those instructions to control the light source 330. The light source 200 then changes color or may be altered in some way having an effect on the illumination of the gemstone 340.

In addition to user input, data collected by the mobile device 120 may be processed by the system 105 to determine the appropriate instructions to send 310 for the determine visual effect on the illumination of the gemstone 340. The collected data may include audio data 380 sampled by the microphone of the mobile device 120, visual data 370 sampled by the camera, or other external data 350 collected from the web or a third party device connected via the internet or other network to the mobile device 120. This advantageously allows the device to manipulate the illumination of the gemstone 340 based on audio data 380, visual data 370, and other data from interacting applications downloaded on third party devices and other sources.

For example, if the mobile device 120 detects music being played, the system 105 may send instructions to strobe the light source 200. Additionally, the frequency or color of flashing may reflect the mood of the sound recorded by the mobile device 120. For example, if the mobile 120 device records a high frequency or loud music, the light source 200 could flash a red color at a fast pace. Similarly, if slow frequency or soft music is playing the light source 200 may be instructed 310 to slowly flash a blue color.

In some embodiments, the camera may record visual data 370 that is reflective of the chromatic characteristics of a user's apparel. This input may be processed 360 to determine a color that would match or compliment the color of the outfit. Accordingly, the gemstones 100 on the fashion accessory 110 would then match the outfit. This will allow the system 105 to advantageously match the jewelry to the outfit more closely than possible through naturally occurring gemstones 100 and by comparisons with the human eye.

Additionally, the camera of the mobile device 120 may be used to detect the brightness of the ambient light level and adjust the brightness of the gemstone 100 by controlling the light source 330. Also, the camera may detect certain objects and flash the light source 200 a certain color when those objects are detected.

The device may also process certain external data 350 from the internet or other wireless networks. This external data 350 may be derived from other users of the system when integrated with an application on a mobile device 120. For example, the external data may be used to coordinate a social networking game between users of system 105.

For example, a mobile phone application may instruct the light source 200 to change color or flash when a third party using the system 105 with similar preferences to the user comes within close proximity to the user. In this embodiment, the application may require the users to enter data into the application regarding their preferences in advance. This could be used as a way to meet other users with similar preferences.

Certain methods may be employed using the application on the wireless device to wake up and shut down the system 105. For example, when the wireless link 210 establishes a connection to the mobile device 120, the application may send a push notification asking the user whether the light source 200 should be powered on. Additionally, the application may ask what program or colors the user would like to display. Accordingly, the user may easily use the system 105 without lengthy interaction with the application on the mobile device 120.

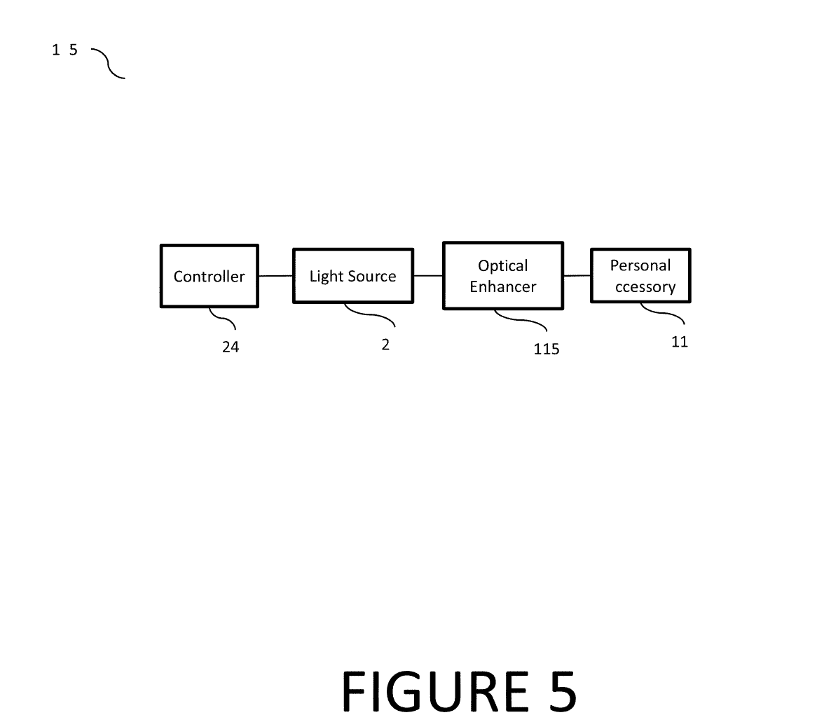

FIG. 5 illustrates a generalized overview of a gemstone illuminator system 105. The system 105 includes a controller 240, a light source 200, an optical enhancer 115, and a personal accessory 110. A manufacturer may construct the device using any type of material that has a capacity to be a light reflector or refractor 115. For example, the optical enhancer 115 may be any plastic, fiber optics, mirrors, prism, or other material that has appropriate qualities for manipulating and or accenting light. Thus the controller 240 may control light source 240 to exhibit a multitude of visual affects once the light exiting the light source 200 is manipulated by the optical enhancer 115. The visual effects may include rainbow accents, sparkling, strobing, reflection, color combinations, color patterns, color matching and others. A user wearing the system 105 on a personal accessory 110 will accordingly add a significant amount of accent and flair to an outfit, and may adjust the accent with the controller 240 as necessary. Additionally, the system 105 allows the user to manipulate the observed color of the optical enhancer 115 according to the color of an outfit or any other preferences a user may have.

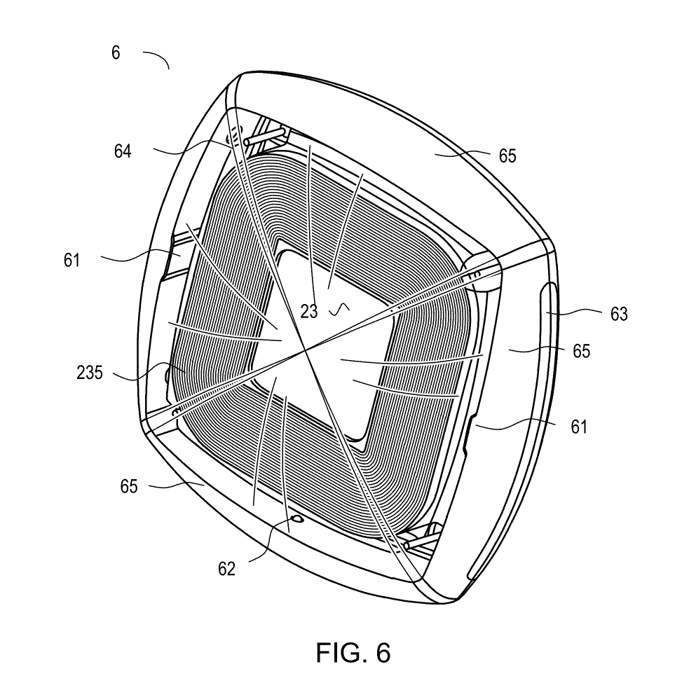

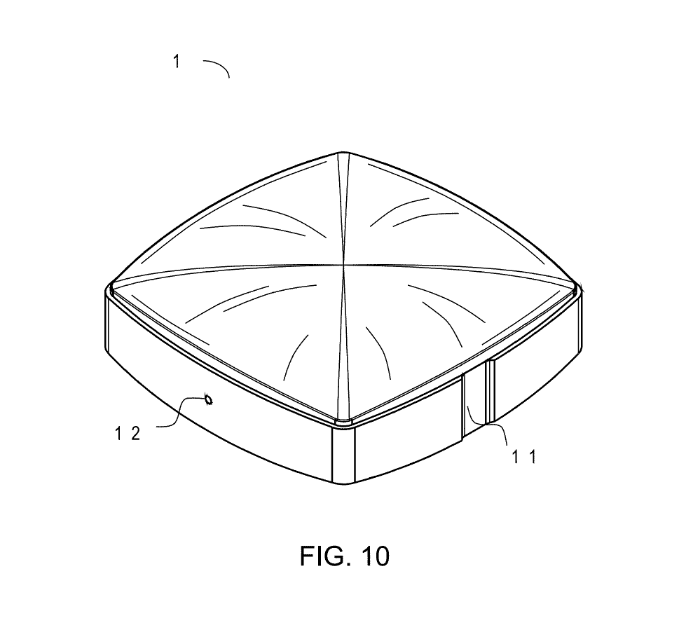

FIG. 6 illustrates an embodiment of a back view of gemstone illuminator mount 600 that allows the mounting of an entire gemstone 100 inside of the mount 600 and behind window 640 but on the opposite side of the battery 230 and charging coil 235 illustrated. In some embodiments, the window 640 on the back view will be pearlescent or opaque, as the gemstone 100 may be situated on the other side or front portion of the gemstone mount 600. The gemstone illuminator mount 600 is built primarily of a frame 650 that may form an o-ring or rectangle and provides the mechanical support for the components. In some embodiments, the frame 650 can include a slide bridge 610 that positions a gemstone 100 inside the frame 650 if a complementary slide groove 1010 (illustrated in FIG. 10) is machined in gemstone 100. Additionally, the frame 650 may contain one or more spring balls 620 to prevent the gemstone from moving once it is slid into place while being guided by slide bridge 610. The spring balls 620 may snap into place into a complementary depression 1020 (illustrated in FIG. 10) machined into gemstone 100 in order to secure the gemstone 100 into place. The spring ball 620 and slide bridge system 610 combination advantageously allows the gemstone 100 to be easily positioned into an optimal position, while by being held firm by the slide bridge 610 and being secured in place with the spring ball 620. In some embodiments, the spring balls 620 removably secure the gemstone 100 in place. This embodiment requires much less machining of gemstone 100 than some of the other embodiments disclosed herein. For example, if the gemstone 100 is a rectangle, only a slide groove 1010 and depression 1020 needs to be machined into gemstone 100. This is minimal compared to embodiments that require an entire recess 150 to be machined into the gemstone 100. In other embodiments, the slide bridge 610 may be reversed in shape and additionally the corresponding slide groove 1010.

In the illustrated embodiment in FIG. 6, the gemstone 100 may be inserted through the back portion shown with the battery 230 and charging coil 235 and other components removed. After the gemstone 100 has been secured on the mount 600, the removed components reinserted once the gemstone 100 is secure. In other embodiments, the gemstone 100 may be inserted through the front side of the mount 600.

As also illustrated in FIG. 6, the mount 600 may also include a wireless induction charging coil 235. In some embodiments, this will advantageously allow the system to be charged without plugging anything in. Accordingly, the entire system may then be permanently or semi permanently glued together. This will allow the components to be waterproof, especially if wireless communication is utilized in order to control the light source and switch the device on and off. In some embodiments, the only switch that may be included is an on and off switch.

Slide bridge 610 and groove 1010 may be a plurality of different shapes including trapezoid and complementary trapezoid, square or rectangle and complementary square or rectangle, cylinder and complementary cylinder, and other additional shapes. Furthermore, spring ball 620 and complementary depression 1020 may take the form of a variety of different spring loaded plunger and complementary depressions or cavities for locking a gemstone 100 in place. In some embodiments, these mechanisms will permanently fix the gemstone 100 to the frame 650. In other embodiments, the spring all 620 or other plunger may reversibly fit into a depression 1020 in the gemstone 100, especially in embodiments where a spring ball 620. For instance a spring ball 620 may be removably attached if the corresponding depression 1020 is relatively shallow, in contrast to a spring loaded pin that plunges deeper into a recess machined into a gemstone 100. Accordingly, depression 1020 may be any depression, channel, tube, bore hole or other depression machined into the gemstone 100 that would allow some form of spring ball 620 or spring loaded portion to extend into the recess.

It has been discovered that slide bridge 610 and complementary groove 1010 and spring ball 620 and complementary depression 1020 are a particularly advantageous and unlikely combination for securing gemstones 100 to the mount 600. For instance, gemstones 100 are traditionally set using metal prongs or other metal lips that are bent down around a stone or using some form of metal that is manipulated to block a stone from moving out of place. However, in some embodiments disclosed here, the gemstone 100 is actually machined to fit into the setting, including by machining the groove 1010 and depression 1020, channel or bore hole. Gemstones are traditionally set in this fashion because gemstone designers generally do not want to machine the gemstone 100 in order to preserve its value. However, if lower value stones are utilized, a very straightforward method of machining the stones to be easily, and in some embodiments, removably placed inside of the gemstone illuminator mount 600 would be very advantageous. Although not traditionally used for gemstones 100, it has been discovered that gemstones 100 may be machined using these types of grooves and holes, to securely fix the gemstone 100 to a mount 600.

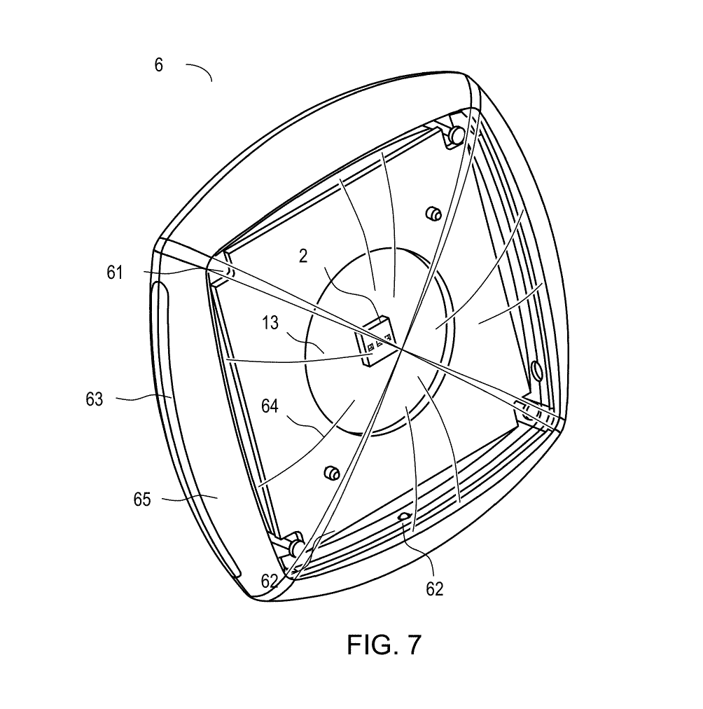

FIG. 7 illustrates a front side view of the gemstone illuminator mount 600 that includes the light source mount 130 and light source 200, for example an LED. In this embodiment, the after the gemstone 100 is fixed into place, the light source mount 130 and light source 200 may be fixed into place behind the gemstone 100 and in close proximity, so that the light source 200 would emit light directly into gemstone 100.

Also illustrated in FIG. 7 is a cover or window 640 that is a clear plastic or other transparent covering for extra security to maintain the gemstone 100 in the frame 650. In some embodiments, window 640 may only be a space on the side of frame 650 and may not include a transparent cover.

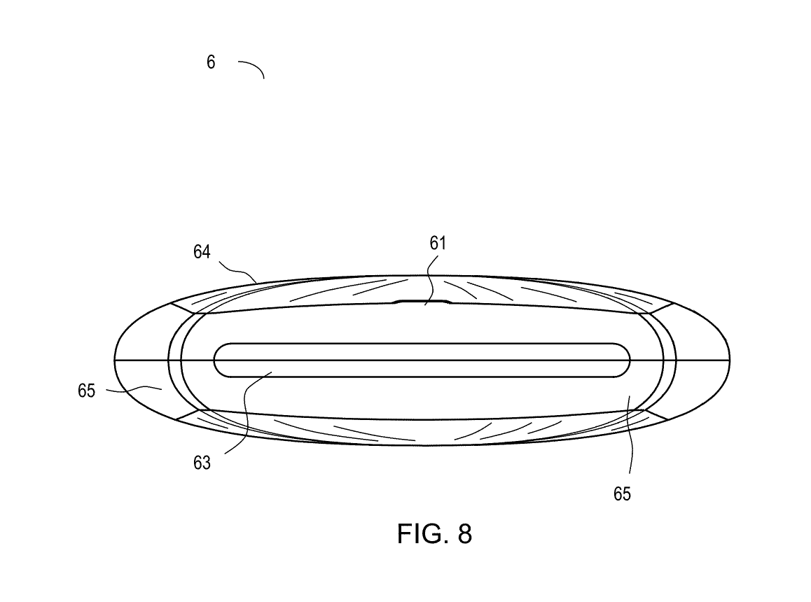

FIG. 8 illustrates a side view of the gemstone illuminator mount 600. The side view illustrates the groove 630, window 640, and a frame 650. In some embodiments, a frame 650 and other components of the gemstone illuminator mount 600 may be glued together to permanently affix them together.

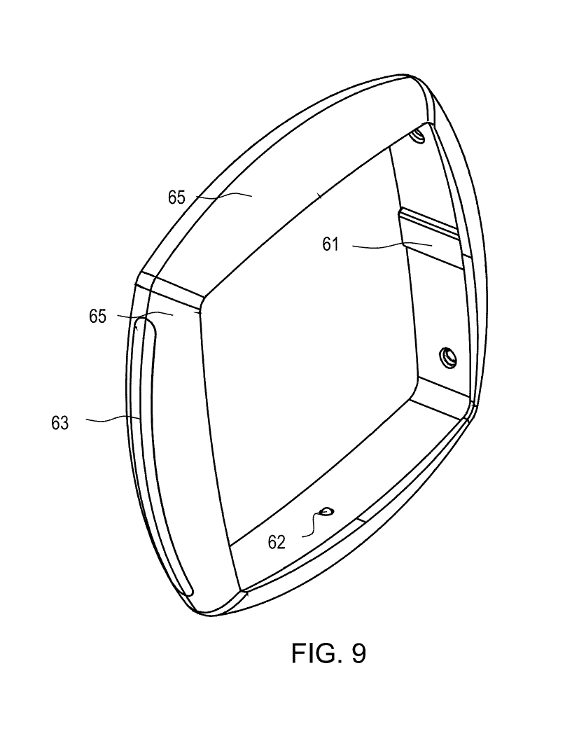

FIG. 9 illustrates a perspective view of a frame 650 in accordance with one embodiment of the present disclosure. The frame 650 includes a slide bridge 610, a spring ball 620, and a groove 630. The frame 650 in FIG. 9 can be seen without the light source 200, light source mount 130, gemstone 100 or other components included. The frame 650, spring ball 620 and groove 630 provide the primary structural components by which a machined gemstone 100 is secured to the mount 600. In some embodiments, a slide bridge 610 and spring ball 620 provide an easily removable mechanism for securing the gemstone 100. For instance, with sufficient force, the gemstone and associated apparatus may be easily forced out and removed from the mounting 600 because spring ball 620 will depress back down if enough force is pushed into gemstone 100 to remove it. Additionally, this system may use less metal than a system requiring metal prongs or a metal lip to be bent around the outside of a 100 to secure it in place. Rather, this embodiment only requires a ball spring, rather than an entire metal setting. This advantageously allows the mount 600 to be cheaper and easier to manufacture.

FIG. 10 illustrates a perspective view of a gemstone 100 that is machined to fit into a mount as illustrated in FIGS. 6-9. In this embodiment, the gemstone 100 includes machined depression 1020 and slide groove 1010. The depression 1020 may be machined into any portion of the gemstone 100 in order to coordinate or line up with the spring ball 620 or other spring loaded restraining device so that when gemstone is slid onto gemstone mount 600, the spring ball 620 inserts into depression 1020. This will allow spring ball 620 to at least removably restrain gemstone 100 in place on the mount 600.

FIGS. 6-10 illustrate one embodiment of a mounting device for restraining gemstone 100 to a mount. In other embodiments, other mechanisms may be utilized to place gemstone into the mount 600. In other embodiments, gemstone 100 may be mounted in other ways, including as disclosed herein and using metal prongs or metal that is bent over the rim of a gemstone 100 once it has been set into place.

Although this disclosure is made with reference to preferred and example embodiments, the systems and methods disclosed are not limited to the preferred embodiments only. Rather, a skilled artisan will recognize from the disclosure herein a wide number of alternatives. Unless indicated otherwise, it may be assumed that the process steps described herein are implemented within one or more modules, including logic embodied in hardware or firmware, or a collection of software instructions, possibly having entry and exit points, written in a programming language, such as, for example C++. A software module may be compiled and linked into an executable program, installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors. The modules described herein are preferably implemented as software modules, but may be represented in hardware or firmware. The software modules may be executed by one or more general purpose computers. The software modules may be stored on or within any suitable computer-readable medium. The data described herein may be stored in one or more suitable mediums, including but not limited to a computer-readable medium. The data described herein may be stored in one or more suitable formats, including but not limited to a data file, a database, an expert system, or the like.

The various illustrative logical blocks, modules, and processes described herein may be implemented as electronic hardware, computer software, or combinations of both. To clearly illustrate this interchangeability of hardware and software, various illustrative components, blocks, modules, and states have been described above generally in terms of their functionality. However, while the various modules are illustrated separately, they may share some or all of the same underlying logic or code. Certain of the logical blocks, modules, and processes described herein may instead be implemented monolithically.

The various illustrative logical blocks, modules, and processes described herein may be implemented or performed by a machine, such as a computer, a processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor may be a microprocessor, a controller, microcontroller, state machine, combinations of the same, or the like. A processor may also be implemented as a combination of computing devices, e.g., a combination of a DSP and a microprocessor, a plurality of microprocessors or processor cores, one or more graphics or stream processors, one or more microprocessors in conjunction with a DSP, or any other such configuration.

The blocks or states of the processes described herein may be embodied directly in hardware, in a software module executed by a processor, or in a combination of the two. For example, each of the processes described above may also be embodied in, and fully automated by, software modules executed by one or more machines such as computers or computer processors. A module may reside in a computer-readable storage medium such as RAM memory, flash memory, ROM memory, EPROM memory, EEPROM memory, registers, hard disk, a removable disk, a CD-ROM, memory capable of storing firmware, or any other form of computer-readable storage medium known in the art. An exemplary computer-readable storage medium can be coupled to a processor such that the processor can read information from, and write information to, the computer-readable storage medium. In the alternative, the computer-readable storage medium may be integral to the processor. The processor and the computer-readable storage medium may reside in an ASIC.

Each computing device may be implemented using one or more physical computers, processors, embedded devices, field programmable gate arrays (FPGAs) or computer systems or a combination or portions thereof. The instructions executed by the computing device may also be read in from a computer-readable medium. The computer-readable medium may be a CD, DVD, optical or magnetic disk, flash memory, laserdisc, carrier wave, or any other medium that is readable by the computing device. In some embodiments, hardwired circuitry may be used in place of or in combination with software instructions executed by the processor. Communication among modules, systems, devices, and elements may be over a direct or switched connections, and wired or wireless networks or connections, via directly connected wires, or any other appropriate communication mechanism. Transmission of information may be performed on the hardware layer using any appropriate system, device, or protocol, including those related to or utilizing Firewire, PCI, PCI express, CardBus, USB, CAN, SCSI, IDA, RS232, RS422, RS485, 802.11, etc. The communication among modules, systems, devices, and elements may include handshaking, notifications, coordination, encapsulation, encryption, headers, such as routing or error detecting headers, or any other appropriate communication protocol or attribute. Communication may also messages related to HTTP, HTTPS, FTP, TCP, IP, ebMS OASIS/eb)<ML, DICOM, DICOS, secure sockets, VPN, encrypted or unencrypted pipes, MIME, SMTP, MIME Multipart/Related Content-type, SQL, etc.

Depending on the embodiment, certain acts, events, or functions of any of the processes or algorithms described herein can be performed in a different sequence, may be added, merged, or left out altogether. Thus, in certain embodiments, not all described acts or events are necessary for the practice of the processes. Moreover, in certain embodiments, acts or events may be performed concurrently, e.g., through multi-threaded processing, interrupt processing, or via multiple processors or processor cores, rather than sequentially.

Conditional language used herein, such as, among others, “can,” “could,” “might,” “may,” “e.g.,” and from the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the logical blocks, modules, and processes illustrated may be made without departing from the spirit of the disclosure. As will be recognized, certain aspects of inventions described herein may be embodied within a form that does not provide all of the features and benefits set forth herein, as some features may be used or practiced separately from others.

1. A system for illuminating a gemstone with a light source as a fashion accessory, the system comprising:
a gemstone that is at least partially transparent to light;
a mount attached to the gemstone;
the mount being attached to a fashion accessory;
a light source positioned adjacent to the gemstone and attached to the mount, the light source positioned so that it illuminates the gemstone when the gemstone is attached to the mount;
a wireless antenna capable of receiving instructions from a wireless computing device relating to a chromatic setting for an output of the light source; and
a controller in communication with the wireless antenna and capable of changing the chromatic qualities of the light source in response to the instructions from the wireless computing device, the controller being in electronic communication with the light source.

2. The system of claim 0, wherein light source is an LED.

3. The system of claim 0, wherein the mount includes a rechargeable battery capable of wireless induction charging.

4. The system of claim 0, wherein the chromatic qualities include the color emitted from the light source.

5. The system of claim 0, wherein the chromatic qualities include a brightness of the color emitted from the light source.

6. The system of claim 0, wherein the gemstone is removably attached to the mount.

7. The system of claim 0, wherein the fashion accessory is a ring, necklace, or bracelet.

8. The system of claim 0, wherein the fashion accessory is a anklet, belt buckle, belly chain, bindi, collar pin, lapel pin, crown, cufflink, earing, tie clip, tie pin, or toe ring.

9. The system of claim 0, wherein the wireless computing device is a mobile phone.

10. A system for illuminating a gemstone with a light source as a fashion accessory, the system comprising:
a gemstone that is at least partially transparent to light, the gemstone being including a slide groove and depression;
a mount that is removably attachable to the gemstone;
a light source positioned adjacent to the gemstone and attached to the mount, the light source positioned so that it illuminates the gemstone when the gemstone is attached to the mount;
a wireless antenna capable of receiving instructions from a wireless computing device relating to a chromatic setting for an output of the light source; and
a controller in communication with the wireless antenna and capable of changing the chromatic qualities of the light source in response to the instructions from the wireless computing device, the controller being in electronic communication with the light source.

11. The system of claim 10, wherein light source is an LED.

12. The system of claim 10, wherein the mount includes a rechargeable battery capable of wireless induction charging.

13. The system of claim 10, wherein the chromatic qualities include the color emitted from the light source.

14. The system of claim 10, wherein the chromatic qualities include a brightness of the color emitted from the light source.

15. The system of claim 10, wherein the gemstone is removably attached to the mount.

16. The system of claim 10, wherein the mount is connected to a necklace, ring, or bracelet.

17. The system of claim 10, wherein the mount contains at least one slide bridge that is mechanically configured to fit at least partially within and slide along a slide groove and wherein the mount contains at least one spring ball that is configured to fit at least partially within a depression.

18. The system of claim 10, wherein the mount is connected to a bracelet.

19. The system of claim 0, wherein the fashion accessory is a anklet, belt buckle, belly chain, bindi, collar pin, lapel pin, crown, cufflink, earing, tie clip, tie pin, or toe ring.

20. The system of claim 10, wherein the wireless computing device is a mobile phone.

21. The system of claim 1, wherein the mount contains at least one slide bridge complementary to the slide groove machined in the gemstone and wherein the mount contains at least one spring ball that is complementary to the depression that is machined into the gemstone.
